(19) United States
(12) Patent Application Publication
(10) Pub. No.: US 2023/0365372 A1
(43) Pub. Date: Nov. 16, 2023

(54) TAPE APPLICATOR AND METHOD OF USING TAPE APPLICATOR

(71) Applicant: 3M INNOVATIVE PROPERTIES COMPANY, St, Paul, MN (US)

(72) Inventors: Andrew J. Hartgers, Ilderton (CA); Utsav Dogra, St. Thomas (CA)

(21) Appl. No.: 18/029,774

(22) PCT Filed: Sep. 28, 2021
(86) PCT No.: PCT/IB2021/058855

§ 371 Date: Mar. 31, 2023

Related U.S. Application Data
(60) Provisional application No. 63/086,885, filed on Oct. 2, 2020.

(51) Int. Cl. B65H 35/00

(52) U.S. Cl. CPC B65H 35/0033; B65H 35/008; B65H 2301/51532; B65H 2701/377

(57) ABSTRACT

A tape applicator for an adhesive tape includes a cutting head. The cutting head includes a base surface and a cutting blade, the cutting blade having a blade base where the cutting blade intersects with and extends from the base surface, and the cutting blade having a cutting edge. The tape applicator further includes a Y-axis extending from a midpoint of the blade base, a longitudinal blade axis extending from the midpoint to a center point of the cutting edge, and a first angle greater than 0 degrees between the Y-axis and the longitudinal blade axis. The tape applicator includes a Z-axis tangent to the base surface, and parallel to the blade base, a cutting edge axis passing through the center point and tangent to the cutting edge, and a second angle less than 80 degrees between the Z-axis and the cutting edge axis.

### BACKGROUND

Generally, an adhesive tape is applied to various surfaces, such as on automotive parts where a two-tone paint scheme is desired. Further, a tape applicator is used to hold an adhesive tape spool and feed the adhesive tape to the surface on which the adhesive tape is to be applied. The tape applicator can include a cutting arrangement that allows cutting of the adhesive tape. The cutting arrangement includes a blade that contacts and cuts the adhesive tape.

### SUMMARY

Conventional tape applicators and their cutting arrangements fail to cut the adhesive tape efficiently, especially when low unwind adhesive peel strength and high elastic elongation adhesive tapes are used. These tapes are frequently used for two-tone paint masking where easy removal from the workpiece is necessary to not damage the underlying base paint layer. In some cases, due to low unwind forces and high adhesive tape elongation, the adhesive tape gets pushed into a gap in the tape guide without cutting the adhesive tape, which is not desirable. This happens since there is not much tension on the tape from the low unwind peel forces and low force needed to elongate the adhesive tape. More particularly, for adhesive tapes having a machine direction (MD) elongation at yield strength, such as greater than 250%, 500% or even 1000% MD elongation, conventional cutting arrangements may only crinkle the adhesive tape rather than severing the adhesive tape.

Hence, there is a need of a tape applicator that cuts the adhesive tape efficiently, and also allows operators to apply adhesive tapes quickly and accurately.

A tape applicator for an adhesive tape includes an integrated cutting arrangement for cutting the adhesive tape while switching from one work surface to another. The tape applicator includes a cutting blade. In one embodiment, the cutting blade is angularly disposed relative to a cutting head, such that the cutting blade provides improved cutting action of low unwind and high elongation adhesive tapes. In another embodiment, the cutting arrangement allows nipping of the adhesive tape which improves tension on the adhesive tape having low unwind forces and high elongation, thereby allowing efficient cutting of the adhesive tape. The tape applicator includes a push button which may be actuated to cut the adhesive tape at a desired location. The tape applicator described in this disclosure allows operators to apply adhesive tapes quickly and accurately to complex work surfaces, such as automotive parts where there is a two-tone paint scheme.

In an aspect of the present disclosure, a tape applicator for an adhesive tape is provided. The tape applicator includes a cutting head. The cutting head includes a base surface and a cutting blade extending from the base surface, the cutting blade having a blade base where the cutting blade intersects with and extends from the base surface, and the cutting blade having a cutting edge disposed above the base surface. The tape applicator also includes a pinching head including a first pinching projection and a second pinching projection separated by a blade slot. The tape applicator further includes a Y-axis extending from a midpoint of the blade base and extending orthogonal to the base surface, a longitudinal blade axis extending from the midpoint to a center point of the cutting edge, and a first angle greater than 0 degrees between the Y-axis and the longitudinal blade axis. The tape applicator includes a Z-axis tangent to the base surface, passing through the midpoint, and parallel to the blade base, a cutting edge axis passing through the center point and tangent to the cutting edge, and a second angle less than 80 degrees between the Z-axis and the cutting edge axis. The tape applicator also includes an adhesive tape spool unwind for dispensing the adhesive tape, wherein at least one of the cutting head and the pinching head is movable from a first position with the cutting blade disposed outside of the blade slot to a second position with the cutting blade disposed at least partially within the blade slot.

In another aspect of the present disclosure, a tape applicator assembly is provided. The tape applicator assembly includes an adhesive tape. The tape applicator assembly also includes an adhesive tape spool unwind for dispensing the adhesive tape. The tape applicator assembly further includes a tape guide wheel disposed in an adhesive tape path for receiving the adhesive tape. The tape applicator assembly includes a cutting head including a base surface and a cutting blade extending from the base surface, the cutting blade having a blade base where the cutting blade intersects with and extends from the base surface, and the cutting blade having a cutting edge disposed above the base surface. The tape applicator also includes a pinching head including a first pinching projection and a second pinching projection separated by a blade slot. The tape applicator further includes a Y-axis extending from a midpoint of the blade base and extending orthogonal to the base surface, a longitudinal blade axis extending from the midpoint to a center point of the cutting edge, and a first angle greater than 0 degrees between the Y-axis and the longitudinal blade axis. The tape applicator includes a Z-axis tangent to the base surface, passing through the midpoint, and parallel to the blade base, a cutting edge axis passing through the center point and tangent to the cutting edge, and a second angle less than 80 degrees between the Z-axis and the cutting edge axis. The tape applicator also includes an adhesive tape spool unwind for dispensing the adhesive tape, wherein at least one of the cutting head and the pinching head is movable from a first position with the cutting blade disposed outside of the blade slot to a second position with the cutting blade disposed at least partially within the blade slot.

In yet another aspect of the present disclosure, a method of using a tape applicator for applying an adhesive tape to a work surface is provided. The method includes placing the tape applicator on the work surface. The tape applicator includes a cutting head comprising a base surface and a cutting blade extending from the base surface, the cutting blade having a blade base where the cutting blade intersects with and extends from the base surface, and the cutting blade having a cutting edge disposed above the base surface; a pinching head comprising a first pinching projection and a second pinching projection separated by a blade slot; a Y-axis extending from a midpoint of the blade base and extending orthogonal to the base surface, a longitudinal blade axis extending from the midpoint to a center point of the cutting edge, and a first angle greater than 0 degrees between the Y-axis and the longitudinal blade axis; and a Z-axis tangent to the base surface, passing through the midpoint, and parallel to the blade base, a cutting edge axis passing through the center point and tangent to the cutting edge, and a second angle less than 80 degrees between the Z-axis and the cutting edge axis. The method includes moving the tape applicator along the work surface for applying the adhesive tape to the work surface. The method also includes moving at least one of the cutting head and the pinching head from a first position with the cutting blade disposed outside of the blade slot to a second position with the cutting blade disposed at least partially within the blade slot. The method further includes engaging an adhesive side of the adhesive tape with the pinching head and a non-adhesive side of the adhesive tape with the cutting blade based on the movement of at least one of the cutting head and the pinching head. The method includes cutting, by the cutting blade, the adhesive tape based on the movement of at least one of the cutting head and the pinching head.

### BRIEF DESCRIPTION OF THE DRAWINGS

Exemplary embodiments disclosed herein may be more completely understood in consideration of the following detailed description in connection with the following figures. The figures are not necessarily drawn to scale. Like numerals used in the figures refer to like components.

FIG. 1 is a perspective view of a tape applicator assembly and a work surface, according to an embodiment of the present disclosure.

FIG. 2 is a perspective view of a tape applicator and an adhesive tape coupled to the tape applicator.

FIG. 3 is a perspective view of a portion of the tape applicator illustrating a cover member and a pair of guide rollers.

FIG. 4 illustrates a cutting head and a cutting blade of the tape applicator.

FIG. 5 is a front perspective view of the cutting head, the cutting blade, and a pinching head of the tape applicator.

FIG. 6 is a front view of the tape applicator illustrating the cutting head, the cutting blade, and the pinching head of the tape applicator.

FIG. 7 is a front view of another tape applicator assembly, according to an embodiment of the present disclosure.

FIG. 8 is a flowchart for a method of using the tape applicator for applying the adhesive tape to the work surface.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less.

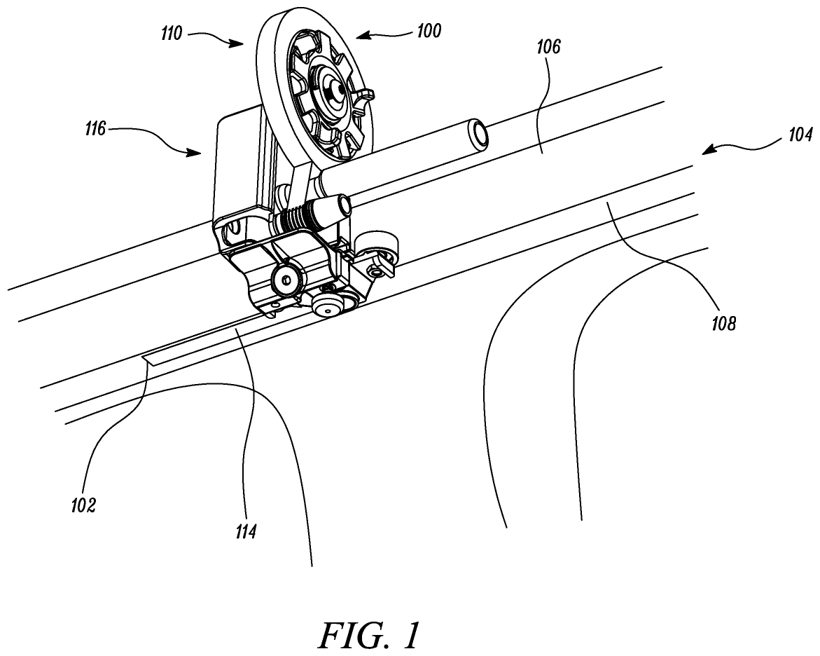

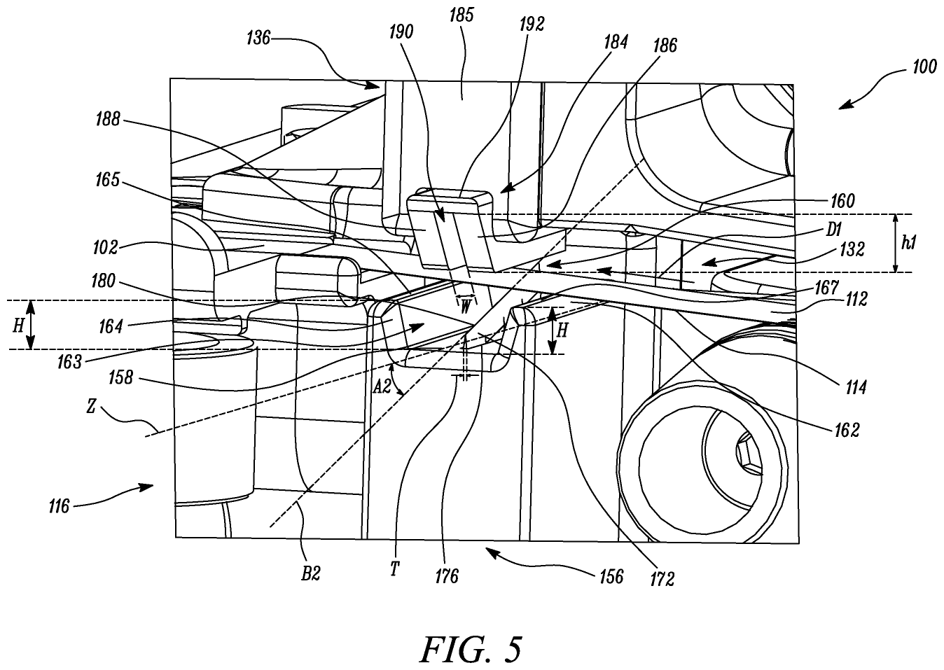

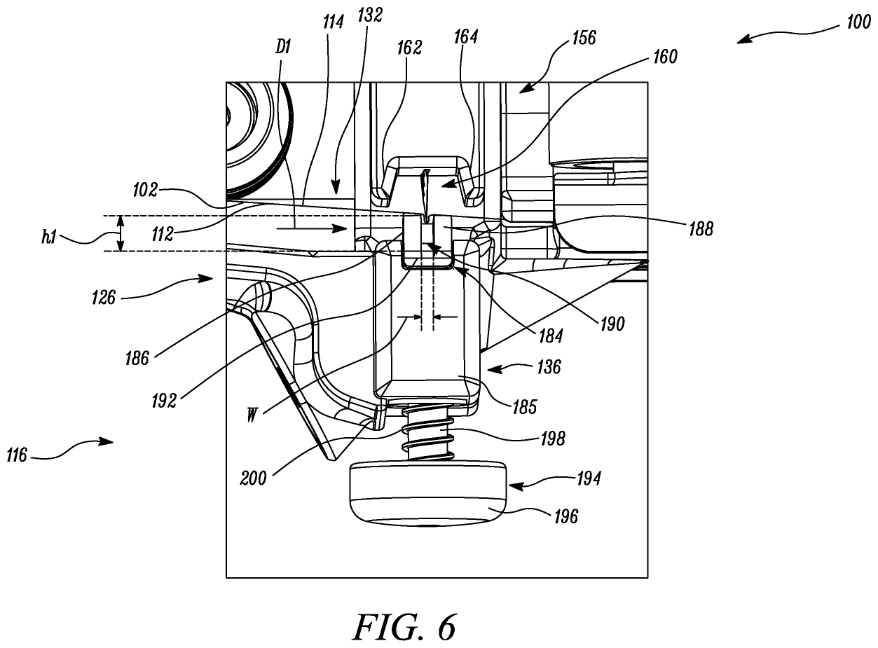

The present disclosure relates to a hand-held tape applicator assembly 100 for an adhesive tape 102. As illustrated in FIG. 1, the tape applicator assembly 100 is used to apply the adhesive tape 102 on a work surface 104. For example, the work surface 104 may include an automotive part, such as a frame of a vehicle. The vehicle may embody a car, without any limitations. The adhesive tape 102 may be applied to the work surface 104 where a two-tone paint scheme is desired. As illustrated, the work surface 104 includes a first surface 106 and a second surface 108 that is angularly disposed relative to the first surface 106. In the illustrated example, the first and second surfaces 106, 108 are substantially perpendicular to each other. Further, the tape applicator assembly 100 includes the adhesive tape 102. More particularly, the tape applicator assembly 100 includes an adhesive tape spool 110 having the adhesive tape 102 wound around a generally circular support (not shown). The adhesive tape 102 includes an adhesive side 112 (shown in FIGS. 5 and 6) that contacts the work surface 104 and a non-adhesive side 114 opposite to the adhesive side 112. In the illustrated example, the adhesive tape 102 is being applied on the second surface 108 of the work surface 104.

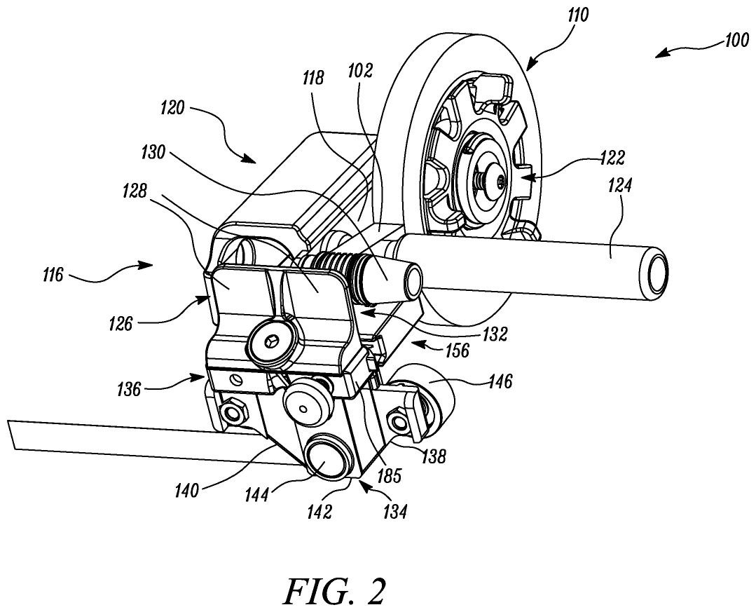

Referring to FIG. 2, the tape applicator assembly 100 includes a tape applicator 116. The tape applicator 116 includes a frame 118 and a handle block 120 coupled to the frame 118. The frame 118 is embodied as a plate that supports various components of the tape applicator 116 and may be made of a material, such as aluminum. The tape applicator 116 includes an adhesive tape spool unwind 122 for dispensing the adhesive tape 102. The adhesive tape spool 110 is coupled to the adhesive tape spool unwind 122. The adhesive tape spool unwind 122 is coupled to the frame 118 by using several components (not shown), for e.g. a mandrel, clamping members, one or more hubs, and the like. The adhesive tape spool unwind 122 is rotatable relative to the frame 118 for dispensing the adhesive tape 102 supplied as a spool of adhesive tape wound on a core. The adhesive tape spool unwind 122 facilitates easy and quick dispensing of the adhesive tape 102. In some examples, the adhesive tape spool unwind 122 may include a brake assembly that restricts undesirable spinning of the adhesive tape spool 110.

The tape applicator 116 also includes a handle 124. The handle 124 has a cylindrical shape and includes a stepped design. The handle 124 is coupled to the handle block 120 and the frame 118. In one example, the handle 124 may be bolted to the handle block 120 and the frame 118. In other examples, the handle 124 may be integral with the frame 118. In the illustrated example, the tape applicator 116 includes only one handle 124 to grasp and guide the tape applicator 116 along the work surface 104. In other examples, the tape applicator 116 may include more than one handle coupled to the handle block 120 and the frame 118. In such examples, the handles may be bolted to either side of the frame 118 forming a generally “V-shaped” structure for grasping with both hands. It should be noted that the design of the handle 124 described herein is exemplary, and the handle 124 may include any other shape or design generally known in the art.

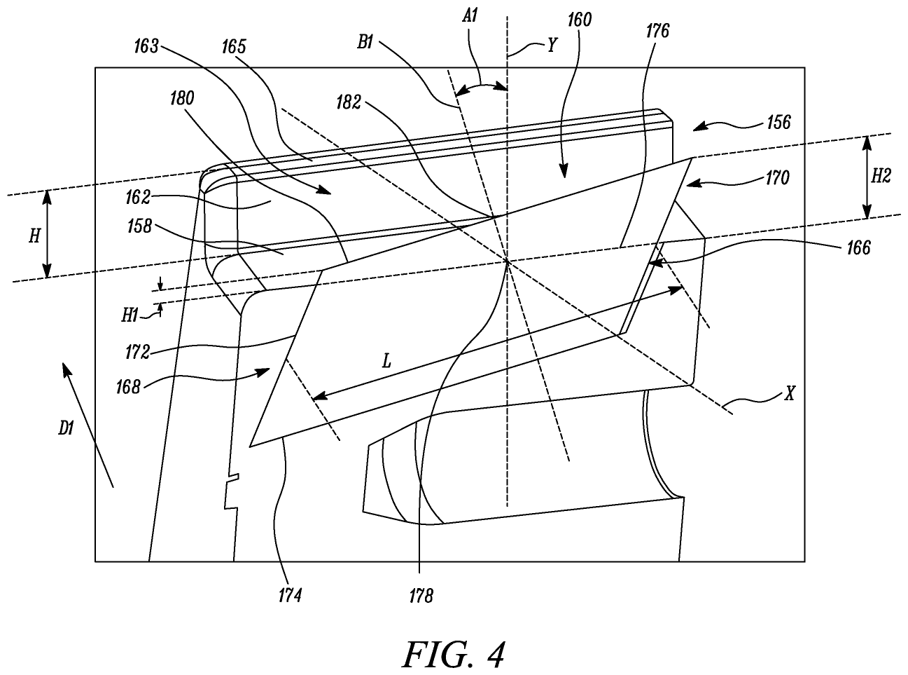

The tape applicator assembly 100 also includes a tape guide wheel 130 disposed between the unwind 122 and a cutting section 131 in a direction “D1” of the adhesive tape travel. The cutting section 131 mentioned herein includes a cutting head 156 (shown in FIG. 4), a cutting blade 160 (shown in FIG. 4), and a pinching head 184 (shown in FIG. 5). The tape guide wheel 130 is disposed in an adhesive tape path 132 for receiving the adhesive tape 102. The adhesive tape 102 leaving the tape guide wheel 130 generally moves along the direction “D1” (shown in FIG. 5) in the adhesive tape path 132. The adhesive tape path 132 may be generally defined as a path that the adhesive tape 102 follows until the adhesive tape 102 is applied on the work surface 104. The adhesive tape 102 leaves the adhesive tape spool unwind 122 from the adhesive tape spool 110 with the adhesive side 112 (see FIGS. 5 and 6) facing up and the non-adhesive side 114 (see FIGS. 5 and 6) facing down such that the non-adhesive side 114 touches the circumference of the tape guide wheel 130. The tape guide wheel 130 retains and moves the adhesive tape 102 in the adhesive tape path 132 irrespective of a diameter of the adhesive tape spool 110 in the unwind 122, as the diameter of the adhesive tape spool 110 changes during use and feed the adhesive tape 102 towards the cutting section 131 for severing with the cutting blade 160. The tape guide wheel 130 is coupled to the frame 118. In an example, the tape guide wheel 130 may be bolted to the frame 118. In another example, the tape guide wheel 130 may be integral with the frame 118. The tape guide wheel 130 is embodied as a generally tubular member having a number of external threads extending along a length of the tape guide wheel 130. The tape guide wheel 130 can include a machined ultra-high molecular weight polyethylene.

Further, the tape applicator 116 includes a first support bracket 126 that is coupled to the frame 118. The first support bracket 126 define a pair of thumb resting surfaces 128 which may improve ergonomics of the tape applicator 116 and provide convenient handling of the tape applicator 116. The tape applicator 116 also includes a second support bracket 136. The second support bracket 136 is coupled to the first support bracket 126 and the frame 118. In an example, the second support bracket 136 may be coupled to the first support bracket 126 and the frame 118 using mechanical fasteners (not shown), such as bolts or screws.

The tape applicator 116 also includes a turning board 134 located after the cutting section 131 in the direction “D1” of the adhesive tape travel. The turning board 134 is disposed in the adhesive tape path 132, such that the cutting head 156 is disposed between the tape guide wheel 130 and the turning board 134 in the adhesive tape path 132. The turning board 134 changes a direction of the adhesive tape 102 in the adhesive tape path 132 to properly align the adhesive tape 102 with the work surface 104. The turning board 134 is coupled to the second support bracket 136. Further, the turning board 134 is also coupled to the second support bracket 136 using mechanical fasteners (not shown), such as bolts or screws. The turning board 134 includes a first turning surface 138, a second turning surface 140, and a vertical surface 142 extending between the first and second turning surfaces 138, 140. It should be noted that the turning board 134 includes two turning surfaces 138, 140 since the tape applicator 116 is designed to be reversibly used. The turning surfaces 138, 140 are rounded for less drag and adhesive tape 102 damage. The first turning surface 138 contacts the non-adhesive side 114 of the adhesive tape 102 for changing the direction of the adhesive tape 102. In an example, the first and second turning surfaces 138, 140 are angled at approximately 45 degrees relative to the vertical surface 142. In the illustrated example, the turning board 134 changes the direction of the adhesive tape 102 by approximately 90 degrees. In other examples, the turning board 134 may change the direction of the adhesive tape 102 by any other angle, as per requirements.

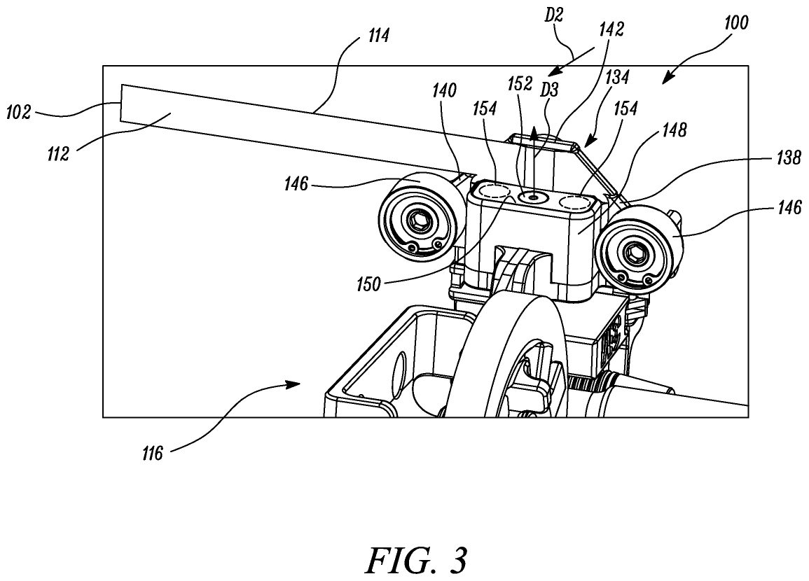

The tape applicator 116 also includes at least one first magnet 144 coupled to the turning board 134. In the illustrated embodiment, the tape applicator 116 includes one first magnet 144, however, the tape applicator 116 may include two or more first magnets 144. The first magnet 144 facilitates attraction of the tape applicator 116 towards the second surface 108 (see FIG. 1) of the work surface 104 (see FIG. 1) along a direction “D2” (shown in FIG. 3). This arrangement provides an attractive force towards the second surface 108 of the work surface 104 which helps to apply the adhesive tape 102 firmly on the second surface 108.

As illustrated in FIG. 3, the tape applicator 116 includes a pair of guide rollers 146 coupled to the turning board 134. The guide rollers 146 contact the first surface 106 (see FIG. 1) when the tape applicator 116 is positioned on the work surface 104 (see FIG. 1). More particularly, the pair of guide rollers 146 slide on the first surface 106 of the work surface 104 that is angularly disposed relative to the second surface 108 of the work surface 104 on which the adhesive tape 102 is applied. The tape applicator 116 also includes a housing 148. The housing 148 is an integral part of the turning board 134. The housing 148 is located such that the guide rollers 146 are disposed on either side of the housing 148. The housing 148 defines a hollow space (not shown). The hollow space of the housing 148 is enclosed by a cover member 150. The cover member 150 is embodied as a generally rectangular plate. The cover member 150 is coupled with the housing 148 using a fastener 152, which may embody a bolt or a screw. It should be noted that while the guide rollers 146 slide and contact the first surface 106 of the work surface 104, the cover member 150 is spaced apart from the first surface 106 of the work surface 104.

Further, the tape applicator 116 includes at least one second magnet 154 disposed proximate the pair of guide rollers 146. The second magnets 154 are received within the hollow space of the housing 148. In the illustrated embodiment, the tape applicator 116 includes a pair of second magnets 154. In other embodiment, the tape applicator 116 may have one second magnet 154 or more than two second magnets 154. The second magnets 154 facilitate attraction of the tape applicator 116 towards the first surface 106 of the work surface 104 along a direction “D2”. The direction “D2” is orthogonal to the direction “D3”. This arrangement provides an attractive force which helps to maintain a firm contact of the tape applicator 116 with the work surface 104.

Further, the turning board 134 also includes a pressure pad 155. The pressure pad 155 contacts the non-adhesive side 114 of the adhesive tape 102 when applying the adhesive tape 102 to the work surface 104. The pressure pad 155 applies a force on the adhesive tape 102 thereby helping to secure the adhesive tape 102 to the work surface 104. The pressure pad 155 may also assist with smoothing out possible wrinkles and/or air bubbles depending on a width of the adhesive tape 102. The pressure pad 155 is generally embodied as a rectangular shaped pad. Alternatively, the pressure pad 155 may have any other shape. A material of the pressure pad 155 may include elastomeric materials, foam materials, bristle brushes, and the like, without any limitations. Referring now to FIG. 4, the tape applicator 116 includes the cutting head 156. The cutting head 156 is disposed proximate the tape guide wheel 130 (see FIG. 2) in the adhesive tape path 132 (see FIG. 2). Specifically, the cutting head 156 is disposed between the tape guide wheel 130 and the turning board 134 (see FIG. 2) in the adhesive tape path 132. The cutting head 156 faces the non-adhesive side 114 (see FIGS. 5 and 6) of the adhesive tape 102 (see FIGS. 5 and 6). The cutting head 156 includes a base surface 158 and the cutting blade 160 extending from the base surface 158.

The cutting head 156 also includes a first portion 162 and a second portion 164 (shown in FIGS. 5 and 6). Each of the first and second portions 162, 164 extend from the base surface 158. Further, the base surface 158, the first portion 162, and the second portion 164 together define a recess 163. The cutting blade 160 is partially received within the recess 163. More particularly, a portion of the cutting blade 160 that projects upwards from the base surface 158 is disposed within the recess 163. The first portion 162 defines a first contact surface 165 and the second portion 164 defines a second contact surface 167 (shown in FIG. 5). The first and second contact surfaces 165, 167 may contact the non-adhesive side 114 (as shown in FIG. 6) of the adhesive tape 102 during the cutting of the adhesive tape 102 to increase a tension on the adhesive tape 102. Further, when the adhesive tape 102 is being applied, the first and second contact surfaces 165, 167 are spaced apart from the adhesive tape 102 (as shown in FIG. 5) thereby preventing touching of the adhesive tape 102 with the cutting blade 160 or the first and second portions 162, 164 except during a cutting event. The positioning of the cutting blade 160 in the recess 163 may also provide a more convoluted path which increases tension during the cutting of the adhesive tape 102.

The first and second portions 162, 164 extend along a height “H” that is defined between the base surface 158 and the corresponding first and second contact surfaces 165, 167. The height “H” of the first and second portions 162, 164 is greater than a height “H1”, “H2” (shown in FIG. 5) of the cutting blade 160. More particularly, the height “H” of the first and second portion 162, 164 is greater than a maximum height, that is the height “H2”, of the cutting blade 160 such that the cutting blade 160 does not project beyond the first and second contact surfaces 165, 167. Positioning the cutting blade 160 in the recess 163 may provide better guarding of the cutting blade 160 thereby making the cutting section 131 finger safe.

Further, the cutting blade 160 is used to cut the adhesive tape 102 received from the tape guide wheel 130 and moving in the direction “D1”. The cutting blade 160 is coupled to the cutting head 156 such that a portion of the cutting blade 160 is disposed above the base surface 158 and remaining portion of the cutting blade 160 is disposed within the cutting head 156. The cutting head 156 defines an elongated slot 166 such that the slot 166 partially receives the cutting blade 160. A thickness of the slot 166 creates an interference with a thickness “T” (shown in FIG. 5) of the cutting blade 160 such that the cutting blade 160 is received within the slot 166 by an interference fit. The cutting blade 160 may be easily replaced by pulling an existing damaged cutting blade 160 from the slot 166. In some examples, the cutting blade 160 may be bonded to the head portion 156 using adhesives or fasteners members, without any limitations. It should be noted that the cutting head 156 along with the cutting blade 160 may be replaced for replacing the existing damaged cutting blade. This approach may allow precise positioning of a cutting blade replacement.

The cutting blade 160 is embodied as a standard breakaway utility blade herein. The cutting blade 160 is typically made from a hard and tough material to easily sever the adhesive tape 102. In an example, the cutting blade 160 may be made of a metal or an alloy. In one specific example, the cutting blade 160 may be made of stainless steel. It should be noted that a design of the cutting blade 160 described herein is exemplary in nature, and the cutting blade 160 may include any other shape and/or design.

The cutting blade 160 includes a first end 168 and a second end 170. Further, the cutting blade 160 includes a length “L” that is defined between the first and second ends 168, 170. The cutting blade 160 includes a pair of side portions 172 and a base portion 174. The side portions 172 of the cutting blade 160 have a tapering profile such that the thickness “T” (shown in FIG. 5) of the cutting blade 160 is defined between the pair of side portions 172. The cutting blade 160 is mounted such that the base portion 174 is received in the slot 166 and the pair of side portions 172 are partially received within the slot 166.

Further, the cutting blade 160 has a blade base 176 where the cutting blade 160 intersects with and extends from the base surface 158. The blade base 176 defines a midpoint 178. An X-axis of the tape applicator 116 passes through the midpoint 178 and may be parallel to the blade base 176, such that the X-axis generally extends along the direction “D1” past the cutting head 156. Further, the tape applicator 116 includes a Y-axis extending from the midpoint 178 of the blade base 176 and extending orthogonal to the base surface 158. The tape applicator 116 also defines a Z-axis (shown in FIG. 6) tangent to the base surface 158, passing through the midpoint 178, and may be parallel to the blade base 176.

The cutting blade 160 has a cutting edge 180 disposed above the base surface 158. The cutting edge 180 is formed at an intersection of the pair of side portions 172. The cutting edge 180 defines a center point 182. In some examples, the cutting edge 180 may include serrations. Further, the cutting blade 160 defines the first height “H1” between the blade base 176 and the cutting edge 180 proximate the first end 168 and the second height “H2” between the blade base 176 and the cutting edge 180 proximate the second end 170. Further, the cutting blade 160 defines a longitudinal blade axis “B1” extending from the midpoint 178 to the center point 182 of the cutting edge 180. The longitudinal blade axis “B1” is generally orthogonal to the base surface 158. Moreover, the tape applicator 116 includes a first angle “A1” greater than 0 degrees between the Y-axis and the longitudinal blade axis “B1”. More particularly, the cutting blade 160 is inclined relative to the base surface 158 such that the first angle “A1” is defined between the Y-axis and the longitudinal blade axis “B1”. The first angle “A1” lies in a range from about 3 degrees to about 8 degrees. In one specific example, the first angle “A1” is approximately equal to 5 degrees. If the first angle “A1” is below 3 degrees, the cutting blade 160 may not allow efficient cutting of the adhesive tape 102. Moreover, if the first angle “A1” is above 8 degrees, a width “W” (shown in FIGS. 5 and 6) of the blade slot 190 may have to be increased for accommodating the cutting blade 160 therein during the cutting event of the adhesive tape 102, which may increase a design complexity of the pinching head 184. In the illustrated example, the cutting blade 160 is disposed to define a forward tilt, defined by the first angle “A1”, relative to the Y-axis. In another example, the cutting blade 160 may be disposed to define a rearward tilt, defined by the first angle “A1”, relative to the Y-axis.

Referring now to FIG. 5, the cutting blade 160 defines a cutting edge axis “B2” passing through the center point 182 (see FIG. 4) and tangent to the cutting edge 180. Moreover, the tape applicator 116 includes a second angle “A2” less than 80 degrees between the Z-axis and the cutting edge axis “B2”. In other examples, the second angle “A2” may be less than 60 degrees, 45 degrees, and 25 degrees. More particularly, the cutting edge 180 is inclined relative to the base surface 158 such that the second angle “A2” is defined between the Z-axis and the cutting edge axis “B2”. The second angle “A2” lies in a range from about 10 degrees to about 18 degrees. In one specific example, the second angle “A2” is approximately equal to 12 degrees.

The second angle “A2” may allow improved cutting action of the adhesive tape 102. It should be noted that the second angle “A2” is optimally selected to provide efficient cutting of the adhesive tape 102 without increasing complexity of the cutting section 131. If the second angle “A2” is very shallow, the cutting blade 160 may not demonstrate a cleaner cutting action. Whereas, if the second angle “A2” is very steep, the pinching head 184 may have to travel a comparatively longer path for cutting of the adhesive tape 102. Further, a height “h1” of the blade slot 190 and the height “H” of the first and second portions 162, 164 may also have to be increased in order to accommodate the cutting blade 160 having the steeper second angle “A2”. In some cases, the steeper second angle “A2” may complicate a design and assembly of the cutting section 131. Accordingly, in some cases, the shallow second angle “A2” may be preferred so that the height “h1” of the blade slot 190 and the height “H” of the first and second portions 162, 164 can be shorter and the adhesive tape 102 is not pulled deeply into the blade slot 190 during the cutting event. The shallow second angle “A2” may simplify the tape applicator design and also facilitate clean cutting of the adhesive type 102. In the illustrated example, the cutting edge 180 tapers along the length “L” of the cutting blade 160 such that the first height “H1” of the cutting blade 160 is lesser than the second height “H2” of the cutting blade 160. In another example, the cutting edge 180 may taper along the length “L” of the cutting blade 160 such that the first height “H1” defined at the first end 168 is greater than the second height “H2” defined at the second end 170.

As shown in FIG. 6, the tape applicator 116 also includes the pinching head 184. In the illustrated example, the pinching head 184 is supported by the second support bracket 136 and is movable relative to the second support bracket 136. More particularly, the pinching head 184 is movable relative to a head housing 185 of the second support bracket 136. The pinching head 184 contacts an adhesive side 112 of the adhesive tape 102 during cutting of the adhesive tape 102. The pinching head 184 includes a first pinching projection 186 and a second pinching projection 188 separated by the blade slot 190. In some examples, a surface of the first and second pinching projections 186, 188 that contacts the adhesive tape 102 may be covered with a material that improves adhesion of the adhesive tape 102 with the first and second pinching projections 186, 188. Moreover, the first and second pinching projections 186, 188 may have a planar profile or a curved profile. The blade slot 190 defines the width “W” and the height “h1”. The cutting blade 160 is in alignment with the blade slot 190. Further, the pinching head 184 includes a base section 192 connected to the first and second pinching projections 186, 188. In some examples, the pinching head 184 may be made of a material, such as aluminum, Delrin®, or any other material, that provides improved adhesion of the adhesive tape 102 with the first and second pinching projections 186, 188.

Moreover, at least one of the cutting head 156 and the pinching head 184 is movable from a first position with the cutting blade 160 disposed outside of the blade slot 190 to a second position with the cutting blade 160 disposed at least partially within the blade slot 190. The adhesive tape 102 is positioned between the pinching head 184 and the base surface 158 when at least one of the cutting head 156 and the pinching head 184 is in the second position. In the illustrated example, the cutting head 156 is fixed and the pinching head 184 moves with respect to the cutting head 156 during cutting of the adhesive tape 102. The pinching head 184 is movable between the first and second positions. The pinching head is illustrated in the first position in FIG. 5, whereas the pinching head is illustrated in the second position in FIG. 6. In the first position, the adhesive tape 102 is free to travel along the direction “D1” and the pinching head 184, the cutting blade 160, and the cutting head 156 are not in contact with the adhesive tape 102. Further, the second position is indicative of the cutting event of the adhesive tape 102. More particularly, in the second position, the first and second pinching projections 186, 188 contact the adhesive side 112 of the adhesive tape 102. The adhesive tape 102 is positioned between the pinching head 184 and the base surface 158 when the pinching head 184 is in the second position. Further, in some instances, when the cutting blade 160 is completely received within the blade slot 190, the base surface 158 may contact the non-adhesive side 114 of the adhesive tape 102.

Further, the tape applicator 116 includes a push button 194 for actuating at least one of the pinching head 184 and the cutting head 156 for cutting the adhesive tape 102. In the illustrated embodiment, the push button 194 is coupled to the pinching head 184. More particularly, the push button 194 is coupled to the base section 192 such that when an operator applies pressure on the push button 194, the pinching head 184 moves along the Y-axis (see FIG. 4) towards the cutting head 156. The push button 194 includes a circular member 196 and a rod member 198 that is coupled to the base section 192. The rod member 198 is partially received within the head housing 185. Further, a spring member 200 is disposed between the base section 192 and the circular member 196 for biasing the pinching head 184 towards the second support bracket 136. The spring member 200 is partially received within the head housing 185.

When the push button 194 is pressed by the operator, the pinching head 184 contacts the adhesive tape 102. Continual movement of the pinching head 184 pushes the adhesive tape 102 towards the cutting blade 160 of the cutting head 156, thereby cutting the adhesive tape 102. Moreover, as mentioned above, during cutting of the adhesive tape 102, the blade slot 190 at least partially receives the cutting blade 160 as the pinching head 184 travels towards the cutting head 156, as illustrated in FIG. 6. Thus, the width “W” and the height “h1” of the blade slot 190 is decided such that the cutting blade 160 can be received within the blade slot 190 without interfering with the first and second pinching projections 186, 188. As the cutting blade 160 does not interact with any other components of the tape applicator assembly 100, except the adhesive tape 102, the cutting blade 160 may have a longer operating life.

It should be noted that the arrangement of the cutting blade 160, the cutting head 156, and the pinching head 184 described herein allows efficient cutting of adhesive tapes having high elongation and low unwind forces. Further, the operator may only press the push button 194 for cutting of the adhesive tape 102. As the push button 194 is distant from the cutting blade 160, any possibility of injury to the operators may be eliminated. In another embodiment, the pinching head 184 is fixed and the cutting head 156 moves with respect to the pinching head 184 during cutting of the adhesive tape 102. In such an embodiment, the push button 194 may be coupled to the cutting head 156.

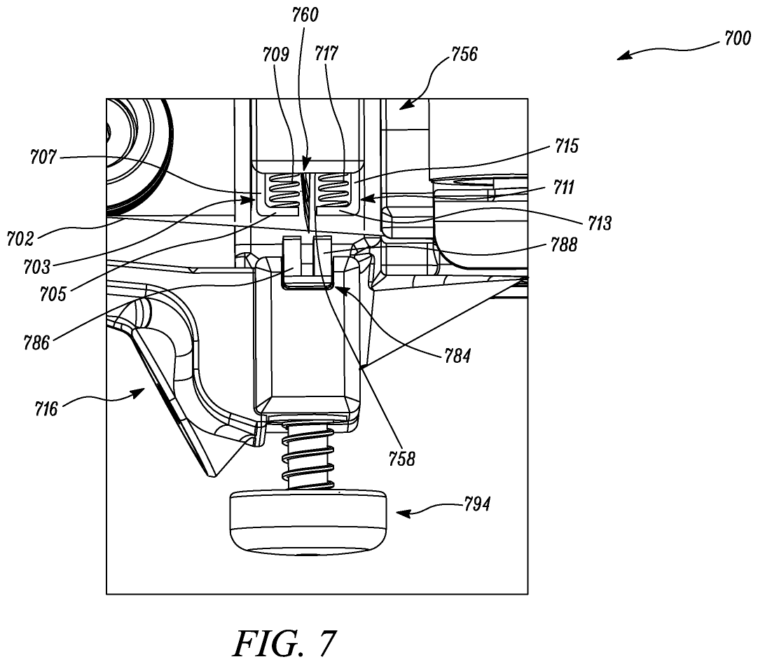

FIG. 7 illustrates a tape applicator assembly 700 including a tape applicator 716 for applying an adhesive tape 702, according to another embodiment of the present disclosure. The tape applicator 716 includes components that are similar to the tape applicator 116 explained in relation to FIGS. 1 to 6. The tape applicator 716 includes a pinching head 784 and a cutting head 756 similar to the pinching head 184 and the cutting head 156 explained in relation to FIGS. 4 to 6. The pinching head 784 includes a first pinching projection 786 and a second pinching projection 788 that are similar in design to the first pinching projection 186 and the second pinching projection 188 of the pinching head 184 explained in relation to FIG. 6. In this example, the pinching head 784 is movable between a first position and a second position. In the second position, the pinching head 784 moves towards the cutting head 756 for cutting the adhesive tape 702. The tape applicator 716 also includes a push button 794 similar to the push button 194 explained in relation to FIG. 6.

The cutting head 756 also includes a cutting blade 760 that is similar in design to the cutting blade 160 of the tape applicator 116 described in relation to FIGS. 4 and 5. The tape applicator 716 may also define the first and second angles (not shown) similar to the first and second angles “A1”, “A2” explained in relation to FIGS. 4 and 5, respectively. In some examples, the first angle “A1” may be 0 degrees or the first angle “A1” may be greater than 0 degrees, as per application requirements.

Further, the cutting head 756 defines a base surface 758 similar to the base surface 158 of the tape applicator 116 explained in relation to FIG. 4. However, the cutting head 756 does not include the first and second portions 162, 164 (see FIGS. 5 and 6). Instead, the tape applicator 716 includes a first bracket 703 extending from the base surface 758 of the cutting head 756. The first bracket 703 is substantially L-shaped. The first bracket 703 defines a first contact portion 705 that is spaced apart from the base surface 758. The first bracket 703 also defines a first vertical portion 707 that is perpendicular to the first contact portion 705. The tape applicator 716 also includes a first spring member 709 disposed between the base surface 758 and the first contact portion 705. A first end of the first spring member 709 rests against the base surface 758 and a second end of the first spring member 709 rests against the first contact portion 705. During cutting of the adhesive tape 702, the first spring member 709 biases the first contact portion 705 towards the adhesive tape 702 thereby maintaining contact of the first contact portion 705 with the adhesive tape 702.

The tape applicator 716 further includes a second bracket 711 extending from the base surface 758, such that the cutting blade 760 is disposed between the first bracket 703 and the second bracket 711. The second bracket 711 is substantially L-shaped. The second bracket 711 defines a second contact portion 713 that is spaced apart from the base surface 758. In some examples, the first and second contact portions 705, 713 may have a planar profile or a curved profile. In the illustrated example, the first and second contact portions 705, 713 include a planar profile. The second bracket 711 also defines a second vertical portion 715 that is perpendicular to the second contact portion 713. The tape applicator 716 further includes a second spring member 717 disposed between the base surface 758 and the second contact portion 713. A first end of the second spring member 717 rests against the base surface 758 and a second end of the second spring member 717 rests against the second contact portion 713. The second spring member 717 biases the second contact portion 713 towards the adhesive tape 702 thereby maintaining contact of the second contact portion 713 with the adhesive tape 702.

Further, the adhesive tape 702 is held between the first pinching projection 786 and the first contact portion 705, and the second pinching projection 788 and the second contact portion 713 when at least one of the cutting head 756 and the pinching head 784 is in the second position. In the illustrated embodiment, the pinching head 784 moves between the first and second positions while the cutting head 756 is stationary. Thus, when the push button of the tape applicator 716 is pushed, the pinching head 784 contacts the adhesive tape 702. Further, continual movement of the pinching head 784 causes the adhesive tape 702 to contact the first and second contact portions 705, 713. Accordingly, the adhesive tape 702 is held between the first pinching projection 786 and the first contact portion 705, and the second pinching projection 788 and the second contact portion 713 when the pinching head 784 is in the second position. A pinching or nipping of the adhesive tape 702 allows the adhesive tape 702 to be pulled deeply between the first and second pinching projections 786, 788, which in turn allows efficient cutting of the adhesive tape 702.

The cutting blade 160, 760 includes the dual angles “A1”, “A2”. The dual angles “A1”, “A2” provide efficient cutting of the adhesive tape 102, 702. Further, the dual angle cutting blade concept described herein is not limited to tape applicators involving direct application of the adhesive tape 102, 702 on the work surfaces 104, 704. In other applications, the dual angle cutting blade concept may be employed on cutting blades associated with table-top pull and cut tape dispensers, or any other tape dispensers of stationary nature, without any limitations.

Further, in some examples, the tape applicator 116, 716 may omit the push button 194, 794 for cutting the adhesive tape 102, 702 and the adhesive tape 102, 702 may be cut similar to table-top pull and cut dispensers. In other examples, the tape applicator 116, 716 may include a different means for advancing the pinching head 184, 784 towards the cutting blade 160, 760 for cutting the adhesive tape 102, 702, without any limitations. In an example, the push button 184, 784 may be replaced by a screw arrangement such that an advancement of a screw member connected to the pinching head 184, 784 causes advancement of the pinching head 184, 784 or the push button 194, 794 may be replaced by a lever or any other component that facilitates a plunging action.

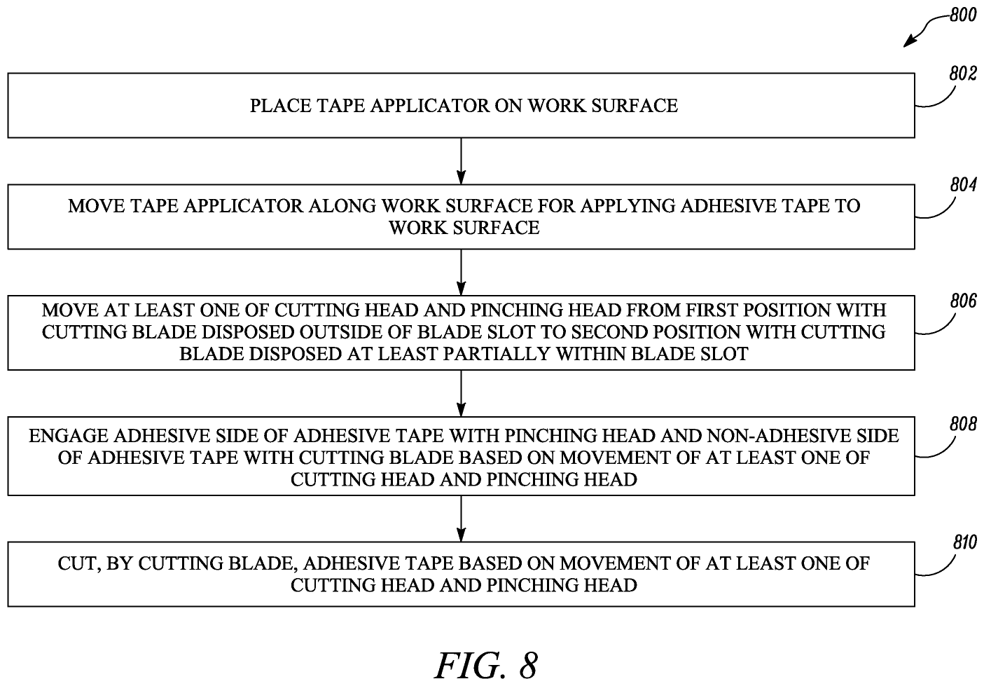

FIG. 8 illustrates a method 800 of using the tape applicator 116 for applying the adhesive tape 102 to the work surface 104. The method 800 will be explained in relation to the tape applicator 116 explained in relation to FIGS. 1 to 6. However, the method 800 is equally applicable to the tape applicator 716 explained in relation to FIG. 7, without any limitations. At step 802, the tape applicator 116 is placed on the work surface 104. The tape applicator 116 includes the cutting head 156 including the base surface 158 and the cutting blade 160 extending from the base surface 158. The cutting blade 160 includes the blade base 176 where the cutting blade 160 intersects with and extends from the base surface 158. The cutting blade 160 includes the cutting edge 180 disposed above the base surface 158. The tape applicator 116 also includes the pinching head 184 including the first pinching projection 186 and the second pinching projection 188 separated by the blade slot 190. The tape applicator 116 further includes the Y-axis extending from the midpoint 178 of the blade base 176 and extending orthogonal to the base surface 158, the longitudinal blade axis “B1” extending from the midpoint 178 to the center point 182 of the cutting edge 180, and the first angle “A1” greater than 0 degrees between the Y-axis and the longitudinal blade axis “B1”.

The tape applicator 116 includes the Z-axis tangent to the base surface 158, passing through the midpoint 178, and may be parallel to the blade base 176, the cutting edge axis “B2” passing through the center point 182 and tangent to the cutting edge 180, and the second angle “A2” less than 80 degrees between the Z-axis and the cutting edge axis “B2”. The first angle “A1” lies in a range from about 3 degrees to about 8 degrees and the second angle “A2” lies in a range from about 10 degrees to about 18 degrees. Moreover, the adhesive tape 102 is coupled with the adhesive tape spool unwind 122 of the tape applicator 116. Further, the tape guide wheel 130 of the tape applicator 116 receives the adhesive tape 102 from the adhesive tape spool unwind 122. The tape guide wheel 130 is disposed proximate the cutting head 156 in an adhesive tape path 132

At step 804, the tape applicator 116 is moved along the work surface 104 for applying the adhesive tape 102 to the work surface 104. More particularly, the pair of guide rollers 146 of the tape applicator 116 contact with the first surface 106 of the work surface 104 for sliding the tape applicator 116 on the first surface 106. The first surface 106 is angularly disposed relative to a second surface 108 of the work surface 104 on which the adhesive tape 102 is applied. Moreover, at least one first magnet 144 attracts the tape applicator 116 towards the second surface 108 of the work surface 104 on which the adhesive tape 102 is applied. Additionally, at least one second magnet 154 attracts the tape applicator 116 towards the first surface 106 of the work surface 104.

At step 806, at least one of the cutting head 156 and the pinching head 184 is moved from the first position with the cutting blade 160 disposed outside of the blade slot 190 to the second position with the cutting blade 160 disposed at least partially within the blade slot 190. In one example, the pinching head 184 is moved with respect to the cutting head 156 for cutting the adhesive tape 102. In another example, the cutting head 156 is moved with respect to the pinching head 184 for cutting the adhesive tape 102. The tape applicator 116 also includes the push button 194. The push button 194 of the tape applicator 116 is actuated for moving at least one of the pinching head 184 and the cutting head 156 for cutting the adhesive tape 102.

At step 808, the adhesive side 112 of the adhesive tape 102 contacts with the pinching head 184 and the non-adhesive side 114 of the adhesive tape 102 contacts with the cutting blade 160 based on the movement of at least one of the cutting head 156 and the pinching head 184. In this example, the adhesive tape 102 is positioned between the pinching head 184 and the base surface 158 when at least one of the cutting head 156 and the pinching head 184 is in the second position. At step 810, the cutting blade 160 cuts the adhesive tape 102 based on the movement of at least one of the cutting head 156 and the pinching head 184.

In another embodiment, the method 800 includes a step of holding the adhesive tape 702 between the first bracket 703 extending from the base surface 758 of the cutting head 756 and the first pinching projection 786 of the pinching head 784 during cutting of the adhesive tape 702. The method 800 also includes a step of biasing the first bracket 703 towards the adhesive tape 702 via the first spring member 709. Further, the method 800 includes the step of holding the adhesive tape 702 between the second bracket 711 extending from the base surface 758 of the cutting head 756 and the second pinching projection 788 of the pinching head 784 during cutting of the adhesive tape 702, wherein the cutting blade 760 is disposed between the first bracket 703 and the second bracket 711. The method 800 also includes a step of biasing the second bracket 711 towards the adhesive tape 102 via the second spring member 717.

The tape applicator 116, 716 described herein includes a reversible design. Accordingly, the tape applicator 116, 716 may be adapted to apply the adhesive tape 102, 702 while moving the tape applicator 116, 716 from a left hand side to a right hand side of work surfaces or from the right hand side to the left hand side work surfaces, as per requirements. In one example, all components of the tape applicator 116, 716 may be manufactured using a three-dimensional (3D) printing technique. For example, the components of the tape applicator 116, 716, such as the handle block 120, the first support bracket 126, the second support bracket 136, the turning board 134, the cutting head 156, the pinching head 184, may be manufactured by 3D printing and later assembled to form the tape applicator 116, 716. In another example, the tape applicator 116, 716 in its entirety may be 3D printed.

It should be noted that the components of the tape applicator 116, 716 may be manufactured using other methods, without limiting the scope of the present disclosure. The 3D printed components may be printed using standard Acrylnitril-Butadien-Styrol (ABS). Further, the tape applicator 116, 716 described herein is light in weight, compact in size, and easy to use. Further, the tape applicator 116, 716 allows operators to apply fine line tapes quickly and accurately to paint break lines where there is a two-tone paint scheme. Moreover, the tape applicator 116, 716 includes an interlocking design thereby providing a compact and strong hand-held tool. The tape applicator 116, 716 described herein may be used to apply adhesive tapes on various surfaces, including but not limited to, side frame members or rear frame members of a vehicle. Further, a cutting arrangement associated with the tape applicator 116, 716 described in this disclosure may be used to cut adhesive tapes having low unwind forces and high elongation quickly and easily, thereby increasing usability and product reliability.

1. A tape applicator for an adhesive tape comprising:
a cutting head comprising a base surface and a cutting blade extending from the base surface, the cutting blade having a blade base where the cutting blade intersects with and extends from the base surface, and the cutting blade having a cutting edge disposed above the base surface;
a pinching head comprising a first pinching projection and a second pinching projection separated by a blade slot;
a Y-axis extending from a midpoint of the blade base and extending orthogonal to the base surface, a longitudinal blade axis extending from the midpoint to a center point of the cutting edge, and a first angle greater than 0 degrees between the Y-axis and the longitudinal blade axis;
a Z-axis tangent to the base surface, passing through the midpoint, and parallel to the blade base, a cutting edge axis passing through the center point and tangent to the cutting edge, and a second angle less than 80 degrees between the Z-axis and the cutting edge axis; and
an adhesive tape spool unwind for dispensing the adhesive tape,
wherein at least one of the cutting head and the pinching head is movable from a first position with the cutting blade disposed outside of the blade slot to a second position with the cutting blade disposed at least partially within the blade slot.

2. The tape applicator of claim 1, wherein the first angle lies in a range from about 3 degrees to about 8 degrees.

3. The tape applicator of claim 1, wherein the second angle lies in a range from about 10 degrees to about 18 degrees.

4. The tape applicator of claim 1, wherein the cutting blade is in alignment with the blade slot.

5. The tape applicator of claim 1, wherein the adhesive tape is positioned between the pinching head and the base surface when at least one of the cutting head and the pinching head is in the second position.

6. The tape applicator of claim 1 further comprising a push button for actuating at least one of the pinching head and the cutting head for cutting the adhesive tape.

7. The tape applicator of claim 6, wherein the push button is coupled to the pinching head.

8. The tape applicator of claim 1 further comprising:
a first bracket extending from the base surface of the cutting head, the first bracket defining a first contact portion that is spaced apart from the base surface;
a first spring member disposed between the base surface and the first contact portion;
a second bracket extending from the base surface, such that the cutting blade is disposed between the first bracket and the second bracket, the second bracket defining a second contact portion that is spaced apart from the base surface; and
a second spring member disposed between the base surface and the second contact portion.

9. The tape applicator of claim 8, wherein the adhesive tape is held between the first pinching projection and the first contact portion, and the second pinching projection and the second contact portion when at least one of the cutting head and the pinching head is in the second position.

10. The tape applicator of claim 1 further comprising a tape guide wheel disposed in an adhesive tape path for receiving the adhesive tape, wherein the cutting head is disposed proximate the tape guide wheel in the adhesive tape path.

11. The tape applicator of claim 10 further comprising a turning board disposed in the adhesive tape path, such that the cutting head is disposed between the tape guide wheel and the turning board in the adhesive tape path.

12. The tape applicator of claim 11 further comprising a pair of guide rollers coupled to the turning board, wherein the pair of guide rollers slide on a first surface of a work surface that is angularly disposed relative to a second surface of the work surface on which the adhesive tape is applied.

13. The tape applicator of claim 12 further comprising at least one first magnet coupled to the turning board, wherein the at least one first magnet facilitates attraction of the tape applicator towards the second surface of the work surface.

14. The tape applicator of claim 12 further comprising at least one second magnet disposed proximate the pair of guide rollers, wherein the at least one second magnet facilitates attraction of the tape applicator towards the first surface of the work surface.

15. A tape applicator assembly comprising:
an adhesive tape;
an adhesive tape spool unwind for dispensing the adhesive tape;
a tape guide wheel disposed in an adhesive tape path for receiving the adhesive tape;
a cutting head comprising a base surface and a cutting blade extending from the base surface, the cutting blade having a blade base where the cutting blade intersects with and extends from the base surface, and the cutting blade having a cutting edge disposed above the base surface;
a pinching head comprising a first pinching projection and a second pinching projection separated by a blade slot;
a Y-axis extending from a midpoint of the blade base and extending orthogonal to the base surface, a longitudinal blade axis extending from the midpoint to a center point of the cutting edge, and a first angle greater than 0 degrees between the Y-axis and the longitudinal blade axis; and
a Z-axis tangent to the base surface, passing through the midpoint, and parallel to the blade base, a cutting edge axis passing through the center point and tangent to the cutting edge, and a second angle less than 80 degrees between the Z-axis and the cutting edge axis,
wherein at least one of the cutting head and the pinching head is movable from a first position with the cutting blade disposed outside of the blade slot to a second position with the cutting blade disposed at least partially within the blade slot.

16-27. (canceled)

28. A method of using a tape applicator for applying an adhesive tape to a work surface, the method comprising:
placing the tape applicator on the work surface, wherein the tape applicator comprises a cutting head comprising a base surface and a cutting blade extending from the base surface, the cutting blade having a blade base where the cutting blade intersects with and extends from the base surface, and the cutting blade having a cutting edge disposed above the base surface; a pinching head comprising a first pinching projection and a second pinching projection separated by a blade slot; a Y-axis extending from a midpoint of the blade base and extending orthogonal to the base surface, a longitudinal blade axis extending from the midpoint to a center point of the cutting edge, and a first angle greater than 0 degrees between the Y-axis and the longitudinal blade axis; and a Z-axis tangent to the base surface, passing through the midpoint, and parallel to the blade base, a cutting edge axis passing through the center point and tangent to the cutting edge, and a second angle less than 80 degrees between the Z-axis and the cutting edge axis;
moving the tape applicator along the work surface for applying the adhesive tape to the work surface;
moving at least one of the cutting head and the pinching head from a first position with the cutting blade disposed outside of the blade slot to a second position with the cutting blade disposed at least partially within the blade slot;
engaging an adhesive side of the adhesive tape with the pinching head and a non-adhesive side of the adhesive tape with the cutting blade based on the movement of at least one of the cutting head and the pinching head; and
cutting, by the cutting blade, the adhesive tape based on the movement of at least one of the cutting head and the pinching head.

29-34. (canceled)

35. The method of claim 28 further comprising:
coupling the adhesive tape with an adhesive tape spool unwind of the tape applicator; and
receiving, by a tape guide wheel of the tape applicator, the adhesive tape from the adhesive tape spool unwind, wherein the tape guide wheel is disposed proximate the cutting head in an adhesive tape path.

36. The method of claim 28 further comprising contacting a pair of guide rollers of the tape applicator with a first surface of the work surface for sliding the tape applicator on the first surface, wherein the first surface is angularly disposed relative to a second surface of the work surface on which the adhesive tape is applied.

37-38. (canceled)

39. The method of claim 28 further comprising holding the adhesive tape between a first bracket extending from the base surface of the cutting head and a first pinching projection of the pinching head during cutting of the adhesive tape.

40. (canceled)

41. The method of claim 39 further comprising holding the adhesive tape between a second bracket extending from the base surface of the cutting head and a second pinching projection of the pinching head during cutting of the adhesive tape, wherein the cutting blade is disposed between the first bracket and the second bracket.

42. (canceled)
